(19) United States
(12) Patent Application Publication
(10) Pub. No.: US 2018/0172146 A1
(43) Pub. Date: Jun. 21, 2018

(54) VALVE BODY FOR HYDRAULIC CONTROL DEVICE, AND PRODUCTION METHOD THEREFOR

(71) Applicant: MAZDA MOTOR CORPORATION, Hiroshima (JP)

(72) Inventors: Tatsuya UESUGI, Onomichi-shi, Hiroshima (JP); Kazuhiko UEDA, Hatsukaichi-shi, Hiroshima (JP)

(73) Assignee: MAZDA MOTOR CORPORATION, Hiroshima (JP)

(21) Appl. No.: 15/738,158

(22) PCT Filed: Jun. 21, 2016
(86) PCT No.: PCT/JP2016/002991

§ 371 Date: Dec. 20, 2017

(30) Foreign Application Priority Data
Jun. 23, 2015 (JP) 2015-125943

(51) Int. Cl. F16H 61/431; B22F 3/02; F16H 61/00

(52) U.S. Cl. CPC F16H 61/431; B33Y 10/00; F16H 61/0025; B22F 3/02

(57) ABSTRACT

A valve body for a hydraulic control system includes a single valve body component (10) having a plurality of valve insertion holes (31, 33) into which a plurality of valves are inserted, respectively, and a plurality of oil passages (69) each communicating with at least one of the valve insertion holes (31, 33). All portions of the valve body component (10) except cavities including the valve insertion holes (31, 33) and the oil passages (69) are integral and continuous with one another.

### TECHNICAL FIELD

The present invention relates to a valve body for a hydraulic control system (device) for use to control the hydraulic pressure of, for example, an automatic transmission of a vehicle, and a method for producing the valve body.

### BACKGROUND ART

In general, an automatic transmission installed in a vehicle includes a hydraulic control system, which controls the supply and discharge of engagement hydraulic oil into and from a hydraulic pressure chamber of each of a plurality of frictional engagement elements forming a transmission mechanism, the supply of lubricating oil to target portions of the interior of a transmission case, and the supply of oil to a torque converter, for example.

As disclosed in Patent Document 1, a known valve body for a hydraulic control system includes a plurality of valve body components, which are layered. These valve body components and separate plates are unitized by being fastened together using a plurality of bolts with one of the separate plates interposed between facing surfaces of each adjacent pair of the valve body components. Each of the layered valve body components is formed using a die by die casting of aluminum or any other process. This allows such valve body components to be precisely and efficiently produced in large quantity.

The valve body includes a solenoid valve, a spool valve, and any other valve assembled thereto. At least one of the layered valve body components has a plurality of valve insertion holes into each of which a small-diameter portion of the solenoid valve extending from a solenoid portion of the solenoid valve, a spool of the spool valve, or any other component is inserted. These valve insertion holes are formed by machining (in particular, cutting) the at least one of the die-casted valve body components. These valve insertion holes extend in a direction parallel to the facing surfaces.

Each of the layered valve body components has a plurality of oil passages each communicating with at least one of the valve insertion holes. These oil passages, which extend along the facing surfaces of each adjacent pair of the valve body components, are formed through the formation of the valve body components with a die. Thus, removal of the die and the draft of the die need to be taken into account when the oil passages are designed.

Specifically, as shown in FIG. 7, in order to enable removal of a die 201 which is designed to be removed in the direction indicated by the arrow, all oil passages 101 of a valve body component 100 each have an opening extending across the entire length of the oil passage 101 and formed through a facing surface 111 of the valve body component 100. This allows the cross section of each oil passage 101 to be in the shape of a groove having a predetermined depth from the facing surface 111 in a direction orthogonal to the facing surface (in the thickness direction of the valve body component 100). The cross section of the oil passage 101 is tapered with the draft of the die taken into account.

The oil passage openings of each layered valve body, which are formed through the associated facing surface, are closed with a separate plate. Opposite ones of the oil passages of two of the valve body components adjacent to each other with the separate plate interposed therebetween communicate with each other through an associated one of communication holes of the separate plate.

### CITATION LIST

### Patent Documents

PATENT DOCUMENT 1: Japanese Unexamined Patent Publication No. 2013-253653

### SUMMARY

### Technical Problem

However, if an attempt is made to allow the deepest portion of each oil passage 101, which has a cross section tapered as shown in FIG. 7, of the previously described known valve body to have a predetermined width, the width L1 of the opening of the oil passage 101 through the facing surface 111 increases. As a result, the entire facing surface 111 needs to have an increased area, resulting in upsizing of the valve body. Conversely, to allow the width L1 of the opening of the oil passage 101 to be equal to a predetermined width, the width of a portion of the oil passage 101 deeper than the opening needs to be reduced. Thus, a valve body component having such oil passages 101 with a reduced width is heavier than a valve body component having oil passages 101 with a constant width throughout their depth. This leads to an increase in the weight of the entire valve body.

In the known valve body, all the oil passages 101 open through the facing surface 111. This prevents three or more of the oil passages 101 of each valve body component 100 from being arranged in the thickness direction of the valve body component. Specifically, as shown in FIG. 7, if only one surface of the valve body component 100 is a facing surface 111, only one oil passage 101 can be arranged in the thickness direction of the valve body component 100. As shown in FIG. 8, if both surfaces of a valve body component 100 are facing surfaces 111 and 112, only two oil passages 101 and 102 can be arranged in the thickness direction of the valve body component. Thus, it is impossible to adopt the layout of oil passages in which three or more oil passages are arranged in the thickness direction of each valve body component 100 having at most two facing surfaces 111.

Furthermore, as shown in FIG. 9, a known valve body has a layered structure including a plurality of valve body components 100a, 100b layered with a separate plate 130 interposed between each adjacent pair of the valve body components. Thus, oil in each of oil passages 101a, 101b, 101c, and 101d may leak from facing surfaces 111a and 111b of the adjacent valve body components under high pressures. To address this problem, the following various countermeasures need to be taken to allow the facing surfaces 111a and 111b to have high sealability.

For example, in order to minimize the formation of the gap between each adjacent pair of layers, many bolts may be used to fasten the valve body components 100a, 100b together, or sheet-like gaskets 141 and 142 may be placed over both surfaces of the separate plate 130. However, such countermeasures increase the number of components and the number of assembly process steps, and cause upsizing of the valve body by the size of spaces corresponding to bolt holes and their surrounding bosses.

To prevent oil leaking from an oil passage 101a from flowing through the facing surface 111a into a different oil passage 101b adjacent to the oil passage 101a, a drain oil passage 103 may be provided between the oil passages 101a and 101b adjacent to each other on the facing surface 111a. However, in this case, the valve body is further upsized by the size of the space where the drain oil passage 103 is arranged.

Furthermore, as shown in FIG. 10, a portion of a valve body component 100 machined to form a valve insertion hole 150 is configured as a D-shaped cross-section portion 154 having a D-shaped cross section and extending from a facing surface 111 to a valve insertion hole formation portion 152 for reasons of removal of a die 201. The D-shaped cross-section portion 154 includes an additional solid portion 156 present between the facing surface 111 and the valve insertion hole formation portion 152. The weight of the valve body increases accordingly.

To solve the problems described above, intensive development has been conducted. However, the precondition that a die is used to form a valve body component to achieve efficient mass production imposes various limitations described above on such development. Thus, under present circumstances, no revolutionary result has been obtained.

It is therefore an object of the present invention to provide a totally novel hydraulic control system valve body that may have a smaller size, a lower weight, a higher capability to seal oil passages, a smaller number of components, and a higher degree of flexibility in designing the oil passages, and a method for producing the valve body.

### Solution to the Problem

In order to achieve the object, one aspect of the present invention is directed to a valve body for a hydraulic control system. The valve body includes: a single valve body component having a plurality of valve insertion holes into which a plurality of valves are inserted, respectively, and a plurality of oil passages each communicating with at least one of the valve insertion holes. All portions of the valve body component except cavities including the valve insertion holes and the oil passages are integral and continuous with one another.

According to the configuration, the single valve body component has all of the valve insertion holes and the oil passages which are required of the valve body. This allows the number of components of the valve body to be less than that of components of a known valve body including a plurality of valve body components which are stacked, and allows a separate plate interposed between each pair of the valve body components of the known valve body adjacent to each other in the direction in which layers are stacked to be omitted.

All portions of the single valve body component except the cavities including the valve insertion holes and the oil passages are integral and continuous with one another. Thus, all of portions of the single valve body component defining the valve insertion holes and the oil passages (the peripheral walls of the valve insertion holes and the peripheral walls of the oil passages) are also integral and continuous with one another. This prevents oil flowing at high pressure through an oil passage from leaking somewhere along the oil passage, unlike a known valve body including a plurality of valve body components, some of which are combined together to form an oil passage. Thus, various components that have been used to reduce the amount of oil leaking, such as fastening bolts for preventing oil from leaking between facing surfaces of adjacent ones of valve body components, and gaskets for sealing the gap between the facing surfaces, can be omitted. This can reduce the number of components and the number of assembly process steps. In addition, the elimination of bolts reduces the space required to form bolt holes and their surrounding bosses, thereby downsizing the valve body.

In addition, preventing oil from leaking somewhere along the oil passage allows a drain oil passage, which may have been provided to discharge leaking oil, to be omitted. This can further reduce the size of the valve body accordingly.

The single valve body component described above can be formed using a three-dimensional layer manufacturing machine by a three-dimensional layer manufacturing process. If the valve body component is formed by the three-dimensional layer manufacturing process, removal of a die does not have to be taken into account. This can provide a high degree of flexibility in designing the shapes and layout of the oil passages without constraints, such as the constraint that the oil passages must each have an opening extending across the length of the oil passage and formed through an associated one of facing surfaces of valve body components. The high degree of flexibility in designing the oil passages allows the design of the oil passages to be easily changed. In addition, when the design is to be changed, there is no need for reshaping the dies. Thus, the design of the oil passages can be changed in a short period of time at low cost.

Since removal of a die and the draft of a die do not have to be taken into account, the oil passages do not have to each have an opening or openings extending across the entire length of the oil passage and formed through one surface or both opposite surfaces of the valve body component, and to have such a shape and have a cross section tapered down from the opening(s) in a direction away from the opening. Thus, the oil passages can be freely designed. This can prevent increasing the cross-sectional area of a portion of each oil passage near the opening from triggering an increase in the size of a portion of the valve body surrounding the opening of the oil passage, and can prevent reducing the cross-sectional area of a portion of the oil passage near a deepest portion thereof from triggering an increase in the weight of the valve body component. This can reduce the size and weight of the valve body.

In one preferred embodiment, if the valve body component is formed by the three-dimensional layer manufacturing process, the valve insertion holes of the valve body component may each have an axis extending in a direction in which layers are stacked by the three-dimensional layer manufacturing process.

This prevents the inner peripheral surfaces of the valve insertion holes from becoming deformed during the manufacture of the valve body by the three-dimensional layer manufacturing process, thus stably forming the valve body. Thus, the valve insertion holes can be precisely formed, thereby smoothly moving, in particular, a spool through the valve insertion hole for the spool valve.

In one embodiment of the valve body for the hydraulic control system, the valve body component may extend in a first predetermined direction, axes of the valve insertion holes of the valve body component may each extend in a second predetermined direction perpendicular to the first predetermined direction, and may be parallel to one another, and at least two of the oil passages may be spaced apart from each other in a third predetermined direction perpendicular to both of the first and second predetermined directions.

In the one embodiment, three or more of the oil passages may be spaced apart from one another in the third predetermined direction.

Thus, layouts that are unachievable in a known valve body formed with a die and including valve body components can be easily achieved. For example, in particular, three or more oil passages can be spaced apart from one another as described above.

In the one embodiment, at least one of the valve insertion holes may be located between two of the oil passages which are spaced apart from each other in the third predetermined direction.

Such a layout can be also easily achieved.

Another aspect of the present invention is directed to a method for producing a valve body for a hydraulic control system. The valve body has a plurality of valve insertion holes into which a plurality of valves are inserted, respectively, and a plurality of oil passages each communicating with at least one of the valve insertion holes. The method includes: manufacturing the valve body by a three-dimensional layer manufacturing process such that all portions of the valve body except cavities including the valve insertion holes and the oil passages are integral and continuous with one another.

This allows a hydraulic control system valve body including the single valve body component described above to be easily produced.

According to one preferred embodiment of the method for producing a valve body for a hydraulic control system, in the manufacturing of the valve body, the valve insertion holes may be formed such that their axes extend in a direction in which layers are stacked by the three-dimensional layer manufacturing process.

This prevents the inner peripheral surfaces of the valve insertion holes from becoming deformed during the manufacture of the valve body by the three-dimensional layer manufacturing process, thus stably forming the valve body. Thus, the valve insertion holes can be precisely formed, thereby smoothly moving, in particular, a spool through the valve insertion hole for the spool valve.

In one preferred embodiment, if the valve insertion holes are formed to each have an axis extending in the direction in which the layers are stacked by the three-dimensional layer manufacturing process, the direction in which the layers are stacked by the three-dimensional layer manufacturing process may be an upward direction, and in the manufacturing of the valve body, a support portion supporting a product portion of the valve body from below may be manufactured so as to be connected to the product portion, and at least one of the valve insertion holes may be formed in a portion of the product portion above the support portion.

Thus, stacking layers upward by the three-dimensional layer manufacturing process allows the support portion to be manufactured so as to be connected to the product portion of the valve body. After the support portion has been manufactured, at least one of the valve insertion holes is formed. Thus, the at least one valve insertion hole is stably formed with the product portion supported from below by the support portion. This can further improve the dimensional accuracy of the at least one valve insertion hole.

### Advantages of the Invention

As can be seen from the foregoing description, according to a hydraulic control system valve body of the present invention and a method for producing the same, the size and weight of the valve body can be reduced, the capability to seal oil passages can be improved, the number of components can be reduced, and the degree of flexibility in designing the oil passages can be improved.

### BRIEF DESCRIPTION OF THE DRAWINGS

FIG. 1 is a perspective view illustrating a valve body component of a valve body for a hydraulic control system according to an embodiment of the present invention as viewed obliquely from above.

FIG. 2 is a perspective view of the valve body component shown in FIG. 1 as viewed obliquely from below.

FIG. 3 is a plan view of the valve body component shown in FIG. 1.

FIG. 4 is a cross-sectional view showing the internal structure of the valve body component, and taken along the plane IV-IV shown in FIG. 3.

FIG. 5 is a cross-sectional view schematically showing the internal structure of the valve body component as viewed in the length direction of oil passages (the longitudinal direction of the valve body component).

FIG. 6 illustrates a valve body component and support portions that are connected together by a three-dimensional layer manufacturing process.

FIG. 7 is a cross-sectional view schematically showing an exemplary valve body component and an exemplary die for a known valve body.

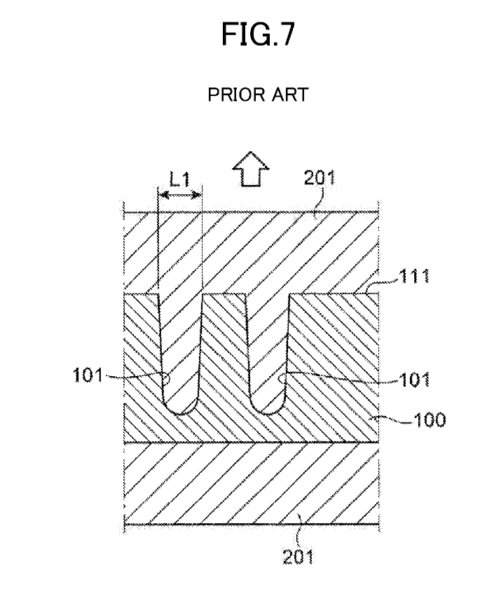

FIG. 8 is a cross-sectional view schematically showing another exemplary valve body component and another exemplary die for a known valve body.

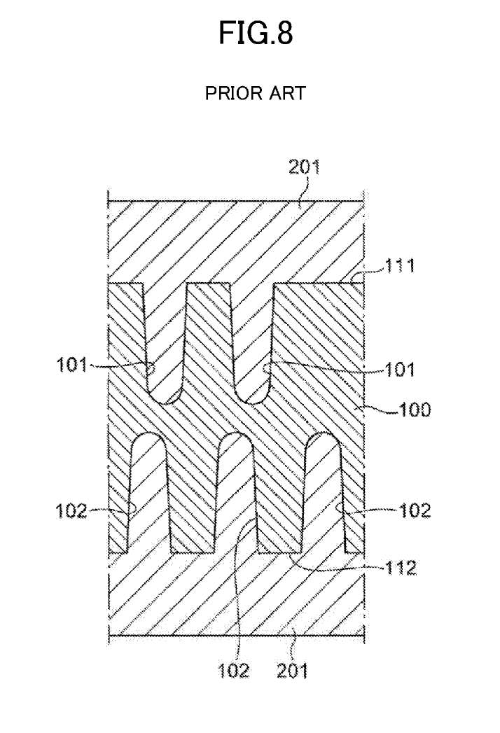

FIG. 9 is a cross-sectional view schematically showing an exemplary boundary between valve body components of a known valve body and its exemplary surrounding area.

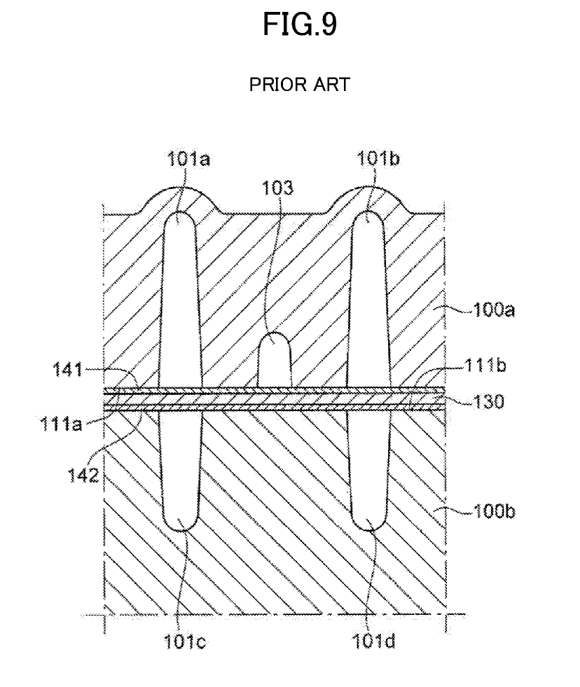

FIG. 10 is a cross-sectional view schematically showing an exemplary valve insertion hole formation portion of a valve body component and an exemplary die for a known valve body.

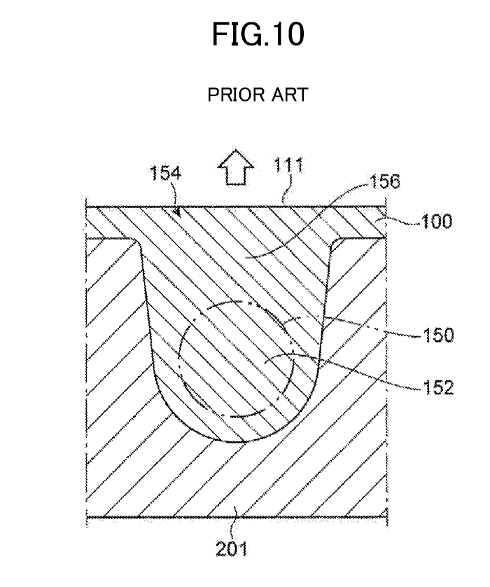

### DESCRIPTION OF EMBODIMENTS

Embodiments of the present invention will now be described in detail with reference to the drawings.

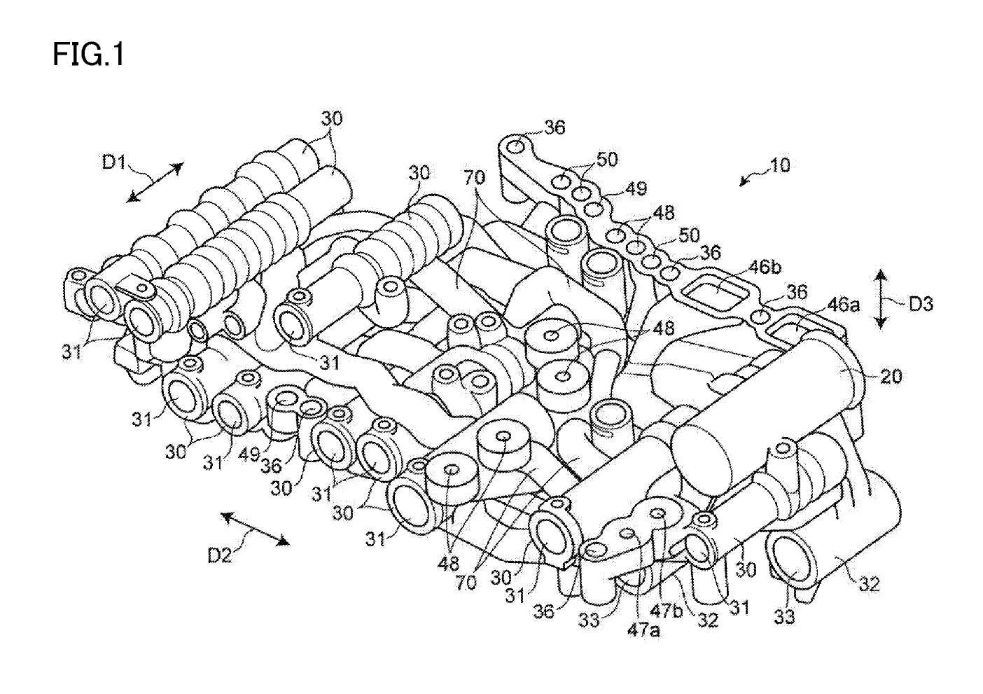

FIGS. 1-4 illustrate a valve body for a hydraulic control system according to an embodiment of the present invention. This valve body includes a single valve body component 10.

As shown in FIGS. 1-4, in this embodiment, the valve body component 10 is generally shaped to extend in a predetermined direction (in the direction D2 shown in FIGS. 1-4 (corresponding to a first predetermined direction)), and is flat. Specifically, the valve body component 10 has a short length in the direction D3 (corresponding to a third predetermined direction) perpendicular to the direction D2. In this embodiment, it can be said that the direction D2 represents the longitudinal direction of the valve body component 10, and the direction D3 represents the thickness direction of the valve body component 10. In addition, it can be said that the direction D1 (corresponding to a second predetermined direction) perpendicular to each of the directions D2 and D3 represents the width direction of the valve body component 10.

The hydraulic control system is used to control the hydraulic pressure supplied to an automatic transmission and a torque converter that are installed in a vehicle. A valve body (the valve body component 10) for the hydraulic control system is assembled to a transmission case (not shown) of the automatic transmission. Specifically, the valve body component 10 is attached to the lower surface of the transmission case. If the valve body component is attached in this manner, the direction D3 corresponds to a vertical direction. In the description of a configuration for the valve body component 10, the upper and lower sides of the valve body component 10 correspond to the upper and lower sides of the attached valve body component. Note that as described below, the direction D1 corresponds to the vertical direction during the manufacture of the valve body component 10. However, where the valve body component 10 should be attached is merely an example. The valve body component 10 may be attached to, for example, an upper surface or a side surface of the transmission case.

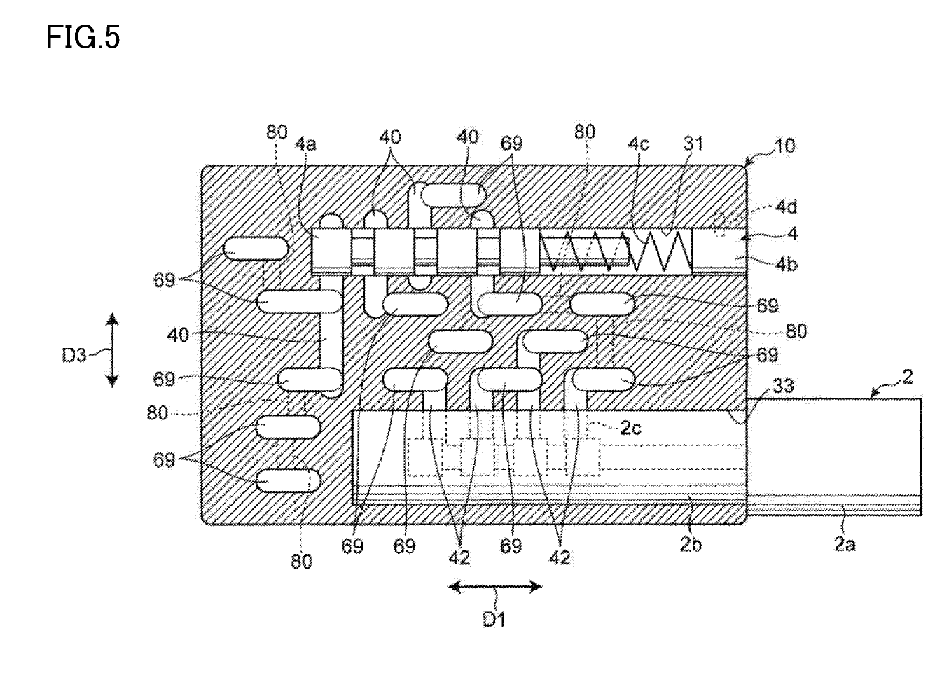

As schematically shown in FIG. 5, the valve body component 10 has a plurality of valve insertion holes 31, 33, and a plurality of oil passages 69 each communicating with at least one of the valve insertion hole 31 or 33. Note that only two of the valve insertion holes 31, 33 are shown in FIG. 5. In this embodiment, the valve insertion holes 31, 33 include a plurality of valve insertion holes 31, and a plurality of valve insertion holes 33. A spool valve 4 is inserted into each valve insertion hole 31, and a small-diameter portion 2b of a solenoid valve 2, described below, is inserted into each valve insertion hole 33. These valves 2, 4 constitute a hydraulic control circuit (not shown) together with the oil passages 69. The number of types of valves inserted into the respective valve insertion holes of the valve body component 10 should not be limited to two, but may be one, three, or more.

The hydraulic control circuit is connected to sources of hydraulic pressure (a mechanical oil pump and an electric oil pump), a hydraulic pressure chamber for each of a plurality of frictional engagement elements (a clutch and a brake) constituting a transmission mechanism, lubrication target portions of the interior of the transmission case, lubrication target portions of the torque converter, a hydraulic pressure chamber of a lockup clutch, and other elements through a plurality of oil passages provided in the wall of the transmission case. Controlling an operation of each of the valves 2 and 4 allows control of, for example, the supply and discharge of engagement hydraulic oil into and from the hydraulic pressure chamber of each frictional engagement element, the supply of lubricating oil to the target portions of the interior of the transmission case, and the supply of oil to the torque converter.

The spool valve 4 includes a spool 4a inserted into, and housed in, the valve insertion hole 31. The spool 4a is movable along the axis of the spool 4a (along the axis of the valve insertion hole 31). The spool valve 4 further includes a stopper 4b fixed at a predetermined location in the valve insertion hole 31 (near the opening of the valve insertion hole 31) by a pin 4d, and a return spring 4c interposed between the stopper 4b and the spool 4a so as to be extendable and retractable along the axis of the spool 4a.

The spool valve 4 has its spool 4a axially moved in accordance with the hydraulic pressure input to a control port (not shown) (corresponding to a cavity) of the spool valve 4. Thus, the spool valve 4 adjusts the discharge pressure from its port portions 40 described below, and selects one of hydraulic pressure supply paths. Specifically, the spool valve 4 functions as a switching valve having various functions, such as the functions of a pressure regulator valve adjusting the discharge pressure of the mechanical oil pump to a line pressure, a manual valve selecting one of the hydraulic pressure supply paths in conjunction with an operation of a shift lever by a vehicle's operator, and a fail-safe valve selecting one of the hydraulic pressure supply paths to achieve a predetermined gear in the event of a failure in the solenoid valve 2.

The solenoid valve 2 includes a cylindrical solenoid portion 2a housing therein a coil, and a cylindrical small-diameter portion 2b having a smaller diameter than the solenoid portion 2a and extending coaxially from the solenoid portion 2a in the direction in which the axis of the solenoid portion 2a extends (in the direction in which the axis of the valve insertion hole 33 extends). The solenoid valve 2 is assembled to the valve body component 10 with the small-diameter portion 2b inserted into the valve insertion hole 33.

A linear solenoid valve or an on/off solenoid valve is used as the solenoid valve 2. The linear solenoid valve is used as a valve to directly control the hydraulic pressure supplied into the hydraulic pressure chamber of the frictional engagement element, for example. The on/off solenoid valve is used as a valve to open and close the hydraulic pressure supply path to the control port of the spool valve 4, for example.

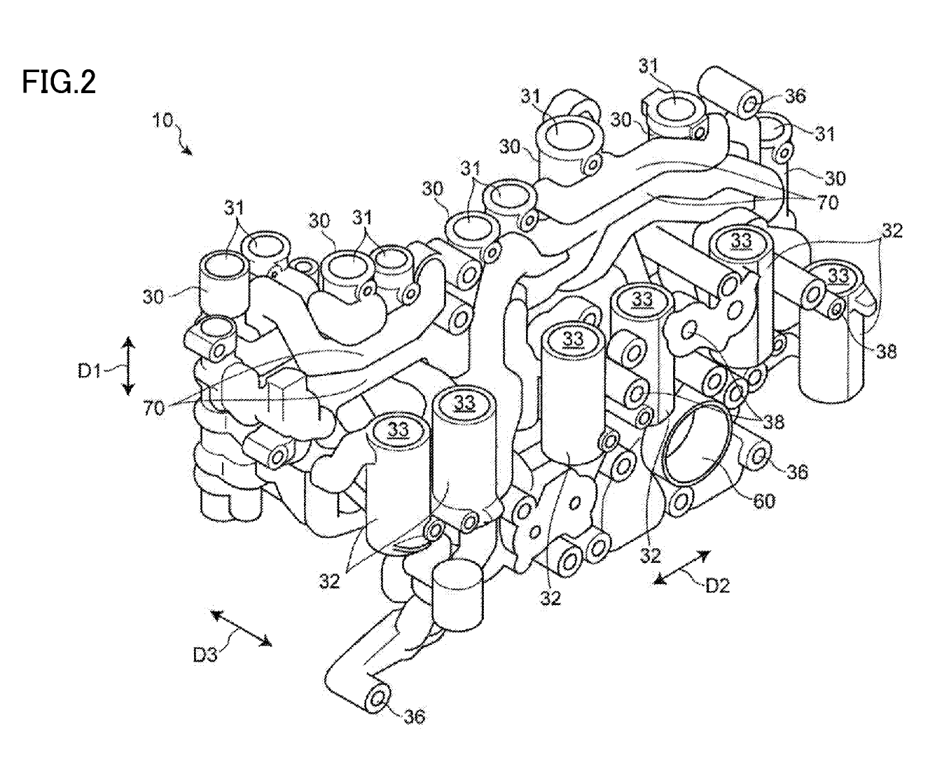

In this embodiment, as shown in FIGS. 1 and 2, the valve insertion holes 31, 33 (all of the valve insertion holes 31, 33 of the valve body component 10) are formed in the valve body component 10 such that the axes of the valve insertion holes 31, 33 extend in the direction D1, and are parallel to one another. All of the valve insertion holes 31, 33 open on the same side in the direction D1. This allows the inner peripheral surfaces of all of the valve insertion holes 31, 33 to be finished from the same direction. In this embodiment, it can be said that the direction D1 corresponds to the direction in which the axes of the valve insertion holes 31, 33 extend. Note that all of the valve insertion holes 31, 33 do not have to open on the same side in the direction D1. The axes of all of the valve insertion holes 31, 33 do not have to extend in the direction D1.

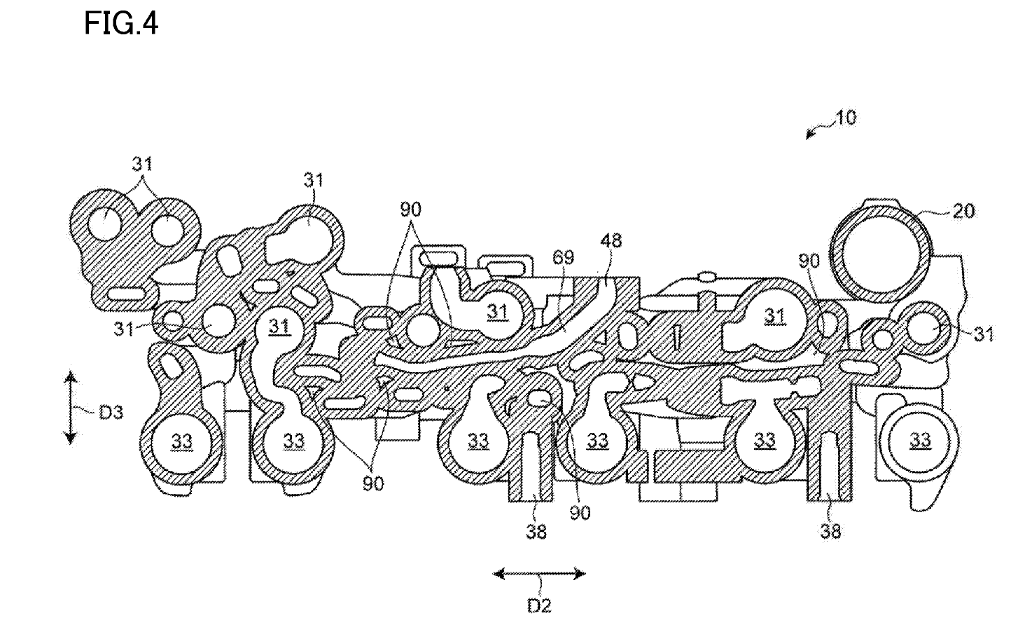

A peripheral wall of each of the valve insertion holes 31 for the spool valves 4 is configured as a substantially tubular spool valve housing portion 30 of the valve body component 10. A peripheral wall of each of the valve insertion holes 33 for the solenoid valves 2 is configured as a substantially tubular solenoid valve housing portion 32 of the valve body component 10. The valve insertion holes 31 for the spool valves 4 each have a smaller diameter and a greater length than the valve insertion holes 33 for the solenoid valves 2. The valve insertion holes 31 for the spool valves 4 are disposed in a relatively upper portion of the valve body component 10 in a concentrated manner, whereas the valve insertion holes 33 for the solenoid valves 2 are disposed in a relatively lower portion of the valve body component 10 in a concentrated manner (see FIG. 4). The valve insertion holes 33 for the solenoid valves 2 are all arranged in the direction D2 (in the longitudinal direction of the valve body component 10) at substantially the same height.

Specific features of the oil passages 69, such as the orientation, layout, cross-sectional shape, and number of the oil passages 69 in the valve body component 10, may be optionally determined. In this embodiment, as schematically shown in FIG. 5, each oil passage 69 has an oblong cross-sectional shape elongated in the direction D1. Most of the oil passages 69 extend in the direction D2. Each oil passage 69 has a necessary length in the direction D2. Depending on the locations of the oil passages, at least two of the oil passages 69 are arranged in the direction D2, or arranged in the direction D3. Unlike the known valve body, three or more of the oil passages 69 can be spaced apart from one another, in particular, in the direction D3. As shown in FIG. 5, at least one of the valve insertion holes 31, 33 (in FIG. 5, the valve insertion hole 31) can be located between two of the oil passages 69 spaced apart from each other in the direction D3. Note that each oil passage 69 does not always extend in a straight line, but extends while being curved or bent as appropriate.

Here, FIGS. 1-3 do not show the oil passages 69 themselves formed inside the valve body component 10, but show peripheral walls 70 of the oil passages 69. The shown peripheral walls 70 are of the oil passages 69 formed near the surface of the valve body component 10. Each oil passage 69 is located inside an associated one of the peripheral walls 70.

The valve body component 10 has a plurality of connection oil passages 80 connecting the oil passages 69 together. For example, some of the connection oil passages 80 extend in the direction D3 to connect together two of the oil passages 69 adjacent to each other in the direction D3, whereas the other connection oil passages 80 extend in the direction D1 to connect together two of the oil passages 69 adjacent to each other in the direction D1.

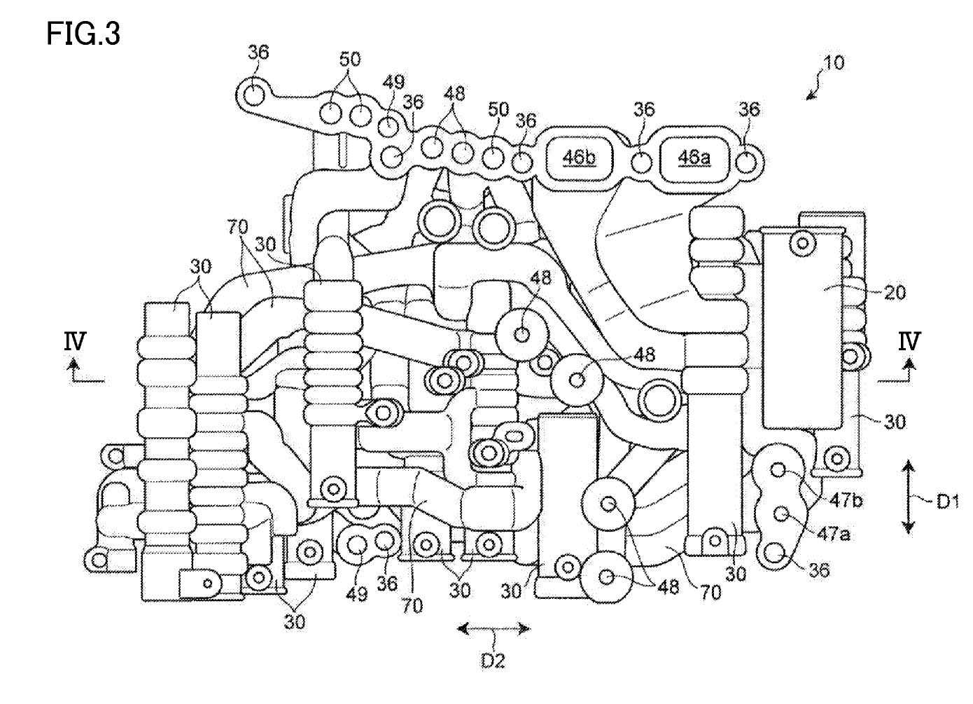

The valve body component 10 further has a plurality of port portions 40 (corresponding to cavities) each communicating with an associated one of the valve insertion holes 31, and a plurality of port portions 42 (corresponding to cavities) communicating with an associated one of the valve insertion holes 33. Some of the oil passages 69 communicating with the valve insertion holes 31 communicate with the associated valve insertion holes 31 through associated ones of the port portions 40. The other oil passages 69 communicating with the valve insertion holes 33 communicate with the associated valve insertion holes 31 through associated ones of the port portions 42. Thus, oil discharged from a solenoid valve 2 (or a spool valve 4) is first delivered through at least a predetermined one of the port portions 42 (or at least a predetermined one of the port portions 40) of the solenoid valve 2 (or the spool valve 4) to one of the oil passages 69 directly connected to the port portion 42 (or the port portion 40). Thereafter, the delivered oil is sent through an associated one of the connection oil passages 80 to another one of the oil passages 69 as needed, and is finally guided to a solenoid valve 2 or a spool valve 4 different from the valve through which the oil has been discharged, or communication ports 46a, 46b, 47a, 47b, 48, 49, and 50 which communicate with the respective oil passages of the transmission case and which will be described below (see FIGS. 1 and 3).

As shown in FIGS. 1, 3, and 4, the valve body component 10 includes a tubular accumulator housing portion 20, which has therein an accumulator insertion hole (corresponding to a cavity). An accumulator (not shown) is inserted into the accumulator insertion hole. The accumulator accumulates pressure through actuation of the mechanical or electric oil pump, and releases the pressure while the oil pump is at rest. The axis of the accumulator housing portion 20 (the accumulator insertion hole) is parallel to the axes of the valve insertion holes 31, 33, and extend in the direction D1. The accumulator insertion hole has an opening facing away from the openings of the valve insertion holes 31, 33 in the direction D1. Note that the hydraulic control circuit may include no accumulator. In that case, the accumulator housing portion 20 is omitted.

As shown in FIGS. 1-3, the valve body component 10 has a plurality of bolt holes 36 (corresponding to cavities) into and through each of which a bolt for fixing the valve body component 10 to the transmission case is inserted and runs. These bolt holes 36 penetrate the valve body component 10 in the direction D3, and open through the upper surface of the valve body component 10 joined to the transmission case and the lower surface thereof facing away from the upper surface.

As shown in FIGS. 2 and 4, the valve body component 10 further has a plurality of bolt holes 38 (corresponding to cavities) into and through each of which a bolt for use to fix, to the valve body component 10, a component of the solenoid valve 2, a component of the spool valve 4, or a bracket for supporting a harness or any other member is inserted and runs. These bolt holes 38 open only through the lower surface of the valve body component 10.

In addition, as shown in FIGS. 1 and 3, the communication ports 46a, 46b, 47a, 47b, 48, 49, and 50 communicating with the respective oil passages of the transmission case open through the upper surface of the valve body component 10. These communication ports 46a, 46b, 47a, 47b, 48, 49, and 50 are each connected to a specific one of the oil passages 69. These specific oil passages 69 communicate with the respective oil passages of the transmission case through the communication ports 46a, 46b, 47a, 47b, 48, 49, and 50.

The communication ports 46a, 46b, 47a, 47b, 48, 49, and 50 are connected through the oil passages of the transmission case to the sources of hydraulic pressure, the hydraulic pressure chamber for each of the frictional engagement elements, the lubrication target portions of the interior of the transmission case, the lubrication target portions of the torque converter, and the hydraulic pressure chamber of the lockup clutch. For example, the communication port 46a is connected to a suction port of the mechanical oil pump, while the communication port 46b is connected to a discharge port of the mechanical oil pump. The communication port 47a is connected to a suction port of the electric oil pump, while the communication port 47b is connected to a discharge port of the electric oil pump. The communication ports 48 are connected to the hydraulic pressure chambers of the frictional engagement elements, respectively, while the communication ports 49 are connected to the lubrication target portions of the interior of the transmission case, respectively. The communication ports 50 are connected to the lubrication target portions of the torque converter and the hydraulic pressure chamber of the lockup clutch, respectively.

As shown in FIG. 2, the valve body component 10 has a communication port 60 communicating with a discharge port of an oil strainer (not shown) disposed in an oil pan. This communication port 60 opens through the lower surface of the valve body component 10.

The valve body component 10 may further include other components, such as a check valve and an orifice member, forming part of the hydraulic control circuit and integrated with the valve body component. The components, such as the check valve and the orifice member, may be configured as a part separate from the valve body component 10. In this case, the valve body component 10 may have an insertion port (corresponding to a cavity) into which the separate part is to be fitted.

The valve body component 10 having the configuration described above is produced with a three-dimensional layer manufacturing machine. Specifically, the valve body component 10 (the valve body) is formed (manufactured) by a three-dimensional layer manufacturing process such that its portions except the cavities including the valve insertion holes 31, 33 and the oil passages 69 are all integral and continuous with one another. This allows the valve body according to this embodiment to be configured as the single valve body component 10.

A specific printing method for use in the three-dimensional layer manufacturing process should not be particularly limited. However, if a metal, such as aluminum, is used as a material of the valve body component 10, a powder-sintered layer manufacturing process may be used. In this process, the following operation is repeated: portions of a layer comprised of densely packed metal powders which correspond to the portions except the cavities are irradiated with electron beams or laser, for example, so as to be sintered and thus manufactured, and a subsequent layer of densely packed metal powders is then formed.

If a resin is used as a material of the valve body component 10, the powder-sintered layer manufacturing process may be used again. However, if a resin is used as a material of the valve body component 10, more printing methods can be used than if a metal material is used thereas. Thus, a printing method satisfying needs, such as an ink-jet method, may be used.

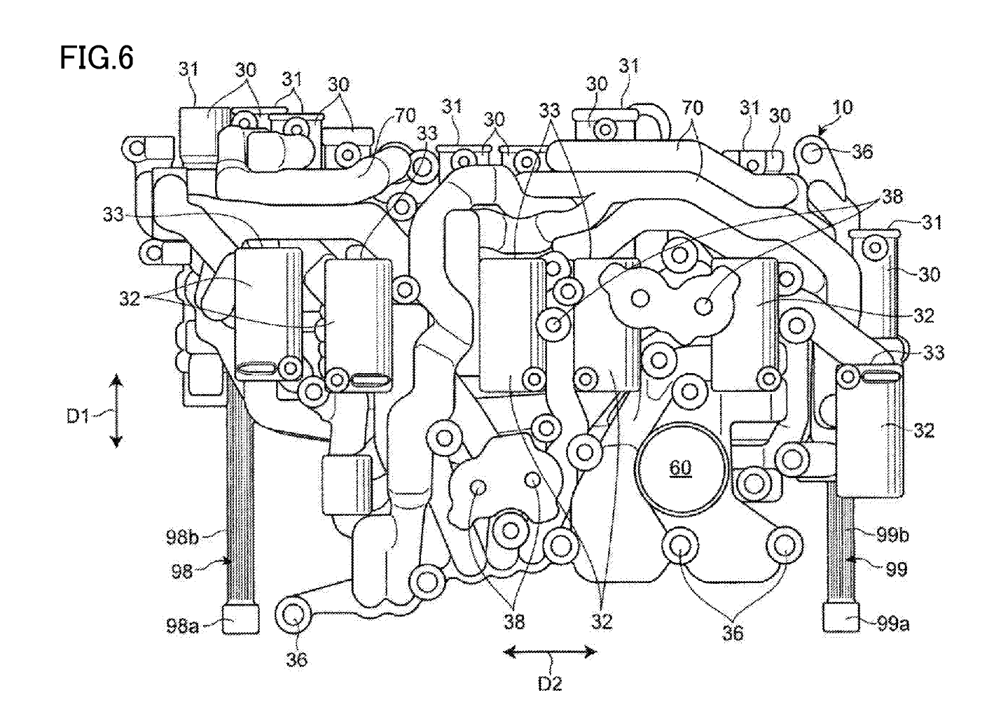

The direction in which layers are stacked to form (manufacture) the valve body component 10 by the three-dimensional layer manufacturing process is an upward direction. The valve insertion holes 31, 33 are formed such that their axes extend in the direction in which the layers are stacked by the three-dimensional layer manufacturing process. Specifically, as shown in FIG. 6, the valve body component 10 is formed such that the direction D1 corresponding to the direction in which the axes of the valve insertion holes 31, 33 extend is a vertical direction. In this embodiment, the valve body component 10 is formed such that the valve insertion holes 31, 33 each have an opening facing upward.

Some of the valve insertion holes 31, 33 (in this embodiment, most of the valve insertion holes 31, 33) are located in a relatively upper portion of the valve body component 10 thus formed. The upper portion including most of the valve insertion holes 31, 33 as described above needs to be effectively supported from below in the direction in which the layers are stacked (the direction D1) during the manufacture of the valve body component 10.

To satisfy the need, it is recommended that as shown in FIG. 6, a plurality of support portions 98, 99 supporting a product portion of the valve body component 10 being manufactured from below be manufactured so as to be integral with the product portion of the valve body component 10. To stably support the product portion, it is recommended that the support portions 98, 99 be manufactured as described above. Each support portion 98, 99 extends upward from its lower end in the direction D1 in which the layers are stacked, and is connected to the product portion of the valve body component 10. Each support portion 98, 99 includes an associated one of circular cylinder portions 98a, 99a formed as its lower end portion in the direction D1 in which the layers are stacked, and an associated one of long tubular portions 98b, 99b extending upward from the associated circular cylinder portion 98a, 99a. The circular cylinder portions 98a, 99a each have a larger diameter than the tubular portions 98b, 99b. The some of the valve insertion holes 31, 33 are manufactured above the support portions 98, 99. It is recommended that if possible, all of the valve insertion holes 31, 33 of the valve body component 10 be manufactured above the support portions 98, 99. However, at least one of the valve insertion holes 31, 33 merely needs to be manufactured above the support portions 98, 99.

Since the support portions 98, 99 are manufactured so as to be integral with the product portion of the valve body component 10 as described above, the some valve insertion holes 31, 33 are stably manufactured above the support portions 98, 99 with the product portion of the valve body component 10 supported from below by the support portions 98, 99. This allows the some valve insertion holes 31, 33 to be precisely formed.

The valve insertion holes 31, 33 are formed to each have an axis extending in the direction in which the layers are stacked by the three-dimensional layer manufacturing process. This prevents the inner peripheral surfaces of the valve insertion holes 31, 33 from becoming deformed during the manufacture of the valve body component 10, thus stably forming the valve body component 10. This allows the valve insertion holes 31, 33 to be precisely formed even if the valve insertion holes 31, 33 are not formed above the support portions 98, 99. Thus, in particular, the spool 4a can be smoothly moved through the valve insertion hole 31 for the spool valve 4. This can achieve responsive hydraulic control.

After the completion of the manufacture of the valve body component 10 by the three-dimensional layer manufacturing process, the support portions 98, 99 are removed, and only the product portion thus remains. The tubular portion 98b, 99b of each support portion 98, 99 is hollow, and thus has a low rigidity. Thus, the support portion 98, 99 can be easily removed.

Thereafter, the inner peripheral surfaces and end surfaces of the valve insertion holes 31, 33, portions of the product portion that were connected to the support portions 98, 99 and other portions are finished. Thus, the valve body component 10 is completed as a product. Mirror finishing, such as shot peening, may be performed as the finishing. The entire valve body component 10 may be subjected to such mirror finishing.

The support portions 98, 99 do not always have to be formed. In particular, if the valve body component 10 of a resin is manufactured by the three-dimensional layer manufacturing process, the support portions 98, 99 may be omitted depending on the printing method used (for example, in a powder-sintered layer manufacturing process).

As can be seen from the foregoing description, the valve body for the hydraulic control system according to this embodiment is configured as the single valve body component 10 formed by the three-dimensional layer manufacturing process. This allows the number of components of the valve body to be less than that of components of a known valve body, which includes a plurality of valve body components stacked, and allows a separate plate interposed between each adjacent pair of the valve body components of the known valve body to be omitted.

All portions of the single valve body component 10 except the cavities including the valve insertion holes 31, 33 and the oil passages 69 are integrated together. Thus, all of portions of the single valve body component defining the valve insertion holes 31, 33 and the oil passages 69 (the peripheral walls of the valve insertion holes 31, 33 and the peripheral walls 70 of the oil passages 69) are also integral and continuous with one another. This prevents oil flowing at high pressure through an oil passage from leaking somewhere along the oil passage, unlike a known valve body including a plurality of valve body components, some of which are combined together to form an oil passage. Thus, various components that have been used to reduce the amount of oil leaking, such as fastening bolts for preventing oil from leaking between facing surfaces of adjacent ones of valve body components, and gaskets for sealing the gap between the facing surfaces, can be omitted. This can reduce the number of components and the number of assembly process steps. In addition, the elimination of bolts reduces the space required to form bolt holes and their surrounding bosses, thereby downsizing the valve body component 10 (the valve body).

In addition, preventing oil from leaking somewhere along the oil passage 69 allows a drain oil passage, which may have been provided to discharge leaking oil, to be omitted. This can further reduce the size of the valve body component 10 (the valve body) accordingly.

If the valve body component 10 is manufactured by the three-dimensional layer manufacturing process, removal of a die does not have to be taken into account. This can provide a high degree of flexibility in designing the shapes and layout of the oil passages 69 without constraints, such as the constraint that the oil passages 69 must each have an opening extending across the length of the oil passage 69 and formed through the facing surface.

Thus, layouts that are unachievable in a known valve body formed with a die and including valve body components can be achieved according to this embodiment. Specifically, as shown in, for example, FIG. 5, at least two (in particular, three or more) of the oil passages 69 can be arranged in the direction D3 perpendicular to the directions D1 and D2 (in the thickness direction of the valve body component 10) between the two valve insertion holes 31, 33 spaced apart from each other in the direction D3, and at least one of the valve insertion holes 31, 33 (in FIG. 5, the valve insertion hole 31) can be located between two of the oil passages 69 spaced apart from each other in the direction D3.

The high degree of flexibility in designing the oil passages 69 allows the design of the oil passages 69 to be easily changed. In addition, when the design is to be changed, there is no need for reshaping dies. Thus, the design of the oil passages 69 can be changed in a short period of time at low cost.

Furthermore, since removal of a die does not have to be taken into account, hollow portions 90 (corresponding to cavities) can be each formed in an especially thick portion of the valve body component 10 as appropriate, as shown in FIG. 4. This can facilitate reducing the weight of the valve body component 10.

Since removal of a die and the draft of a die do not have to be taken into account, the oil passages 69 do not have to each have an opening or openings extending across the length of the oil passage 69 and formed through one surface or both opposite surfaces of the valve body component, and to have such a shape and have a cross section tapered down from the opening(s) in a direction away from the opening, unlike the known valve body. Thus, the oil passages 69 can be freely designed. As a result, although, in the known valve body, increasing the cross-sectional area of a portion of each oil passage near the opening triggers an increase in the size of a portion of the valve body surrounding the opening of the oil passage, and reducing the cross-sectional area of a portion of the oil passage near a deepest portion thereof triggers an increase in the weight of an associated one of the valve body components, such a situation does not happen to the oil passages 69 of the valve body component 10. This can reduce the size and weight of the valve body component 10 (the valve body).

The present invention is not limited to the above embodiment, and capable of substitutions without departing from the scope of the claims.

For example, in the above embodiment, an example in which the present invention is applied to a valve body for a hydraulic control system for use to control the hydraulic pressure of an automatic transmission has been described. However, the present invention can be applied to any hydraulic control system valve body, and is suitable for, in particular, a valve body including many valves.

The foregoing embodiment is merely an example, and the scope of the present invention should not be construed to be limiting. The scope of the present invention should be defined by the appended claims, and all the modifications and changes which fall within the scope of equivalents of the appended claims are within the scope of the present invention.

### INDUSTRIAL APPLICABILITY

The present invention is useful for a valve body for a hydraulic control system and a method for producing the same, and is particularly useful for a valve body including many valves, such as a valve body for a hydraulic control system for use to control the hydraulic pressure of an automatic transmission of a vehicle, and a method for producing the valve body.

### DESCRIPTION OF REFERENCE CHARACTERS

2 Solenoid Valve
4 Spool Valve
10 Valve Body Component
31 Valve Insertion Hole For Spool Valve
33 Valve Insertion Hole For Solenoid Valve
69 Oil Passage
98 Support Portion
99 Support Portion

1. A valve body for a hydraulic control system, the valve body comprising:
a single valve body component having a plurality of valve insertion holes into which a plurality of valves are inserted, respectively, and a plurality of oil passages each communicating with at least one of the valve insertion holes, wherein
all portions of the valve body component except cavities including the valve insertion holes and the oil passages are integral and continuous with one another.

2. The valve body of claim 1, wherein
the valve body component is formed by a three-dimensional layer manufacturing process such that the all portions of the valve body component except the cavities are integral and continuous with one another.

3. The valve body of claim 2, wherein
the valve insertion holes of the valve body component each have an axis extending in a direction in which layers are stacked by the three-dimensional layer manufacturing process.

4. The valve body of claim 1, wherein
the valve body component extends in a first predetermined direction,
axes of the valve insertion holes of the valve body component each extend in a second predetermined direction perpendicular to the first predetermined direction, and are parallel to one another, and
at least two of the oil passages are spaced apart from each other in a third predetermined direction perpendicular to both of the first and second predetermined directions.

5. The valve body of claim 4, wherein
three or more of the oil passages are spaced apart from one another in the third predetermined direction.

6. The valve body of claim 4, wherein
at least one of the valve insertion holes is located between two of the oil passages which are spaced apart from each other in the third predetermined direction.

7. A method for producing a valve body for a hydraulic control system, the valve body having a plurality of valve insertion holes into which a plurality of valves are inserted, respectively, and a plurality of oil passages each communicating with at least one of the valve insertion holes, the method comprising:
manufacturing the valve body by a three-dimensional layer manufacturing process such that all portions of the valve body except cavities including the valve insertion holes and the oil passages are integral and continuous with one another.

8. The method of claim 7, wherein
in the manufacturing of the valve body, the valve insertion holes are formed such that their axes extend in a direction in which layers are stacked by the three-dimensional layer manufacturing process.

9. The method of claim 8, wherein
the direction in which the layers are stacked by the three-dimensional layer manufacturing process is an upward direction, and
in the manufacturing of the valve body, a support portion supporting a product portion of the valve body from below is manufactured so as to be connected to the product portion, and at least one of the valve insertion holes is formed in a portion of the product portion above the support portion.
